(19) United States
(12) Patent Application Publication
(10) Pub. No.: US 2011/0057885 A1
(43) Pub. Date: Mar. 10, 2011

(54) METHOD AND APPARATUS FOR SELECTING A MENU ITEM

(75) Inventor: Daniel Lehtovirta, Espoo (FI)

(73) Assignee: NOKIA CORPORATION, Espoo (FI)

(21) Appl. No.: 12/555,684

(22) Filed: Sep. 8, 2009

(51) Int. Cl. G06F 3/041

(52) U.S. Cl. 345/173

(57) ABSTRACT

An apparatus, having a processor, and a memory including computer program code, the memory and the computer program code configured to, working with the processor, cause the apparatus to perform at least the following: receive indication of a first touch input, determine that the first touch input comprises a rotationally pivoting touch input, provide for display of a plurality of menu items based at least in part on the first touch input, receive indication of a second touch input associated with at least one of the menu items, and perform selection of at least one of the menu items based at least in part on the second touch input is disclosed. A corresponding method, computer readable medium and computer program product are also disclosed.

### TECHNICAL FIELD

The present application relates generally to selecting a menu item.

### BACKGROUND

There has been a recent surge in the use of touch displays on electronic devices. The user may provide input to the electronic device to perform various operations.

### SUMMARY

Various aspects of examples of the invention are set out in the claims.

An apparatus, comprising a processor, and a memory including computer program code, the memory and the computer program code configured to, working with the processor, cause the apparatus to perform at least the following: receive indication of a first touch input, determine that the first touch input comprises a rotationally pivoting touch input, provide for display of a plurality of menu items based at least in part on the first touch input, receive indication of a second touch input associated with at least one of the menu items, and perform selection of at least one of the menu items based at least in part on the second touch input is disclosed.

A method, comprising receiving indication of a first touch input, determining that the first touch input comprises a rotationally pivoting touch input, providing for display of a plurality of menu items based at least in part on the first touch input, receiving indication of a second touch input associated with at least one of the menu items, and performing selection of at least one of the menu items based at least in part on the second touch input is disclosed.

A computer readable medium encoded with instructions that, when executed by a computer, perform: receiving indication of a first touch input, determining that the first touch input comprises a rotationally pivoting touch input, providing for display of a plurality of menu items based at least in part on the first touch input, receiving indication of a second touch input associated with at least one of the menu items, and performing selection of at least one of the menu items based at least in part on the second touch input is disclosed.

A computer program product comprising a computer-readable medium bearing computer program code embodied therein for use with a computer, the computer program code comprising: code for receiving indication of a first touch input, code for determining that the first touch input comprises a rotationally pivoting touch input, code for providing for display of a plurality of menu items based at least in part on the first touch input, code for receiving indication of a second touch input associated with at least one of the menu items, and code for performing selection of at least one of the menu items based at least in part on the second touch input is disclosed.

### BRIEF DESCRIPTION OF THE DRAWINGS

For a more complete understanding of embodiments of the invention, reference is now made to the following descriptions taken in connection with the accompanying drawings in which:

FIGS. 1A-1D are diagrams illustrating examples of a contact associated with a touch input according to an example embodiment;

FIGS. 2A-2D are diagrams illustrating a contact region associated with a rotationally pivoting touch input according to an example embodiment;

FIGS. 3A-3D are diagrams illustrating a plurality of menu items according to an example embodiment;

FIGS. 4A-4D are diagrams illustrating selection of a menu item according to an example embodiment;

FIG. 5 is a flow diagram showing a set of operations for selecting a menu item according to an example embodiment;

FIG. 6 is another flow diagram showing a set of operations for representing text information according to an example embodiment;

FIGS. 7A-7E are diagrams illustrating input associated with a touch display, for example from display 28 of FIG. 8, according to an example embodiment; and

FIG. 8 is a block diagram showing an apparatus according to an example embodiment.

### DETAILED DESCRIPTION OF THE DRAWINGS

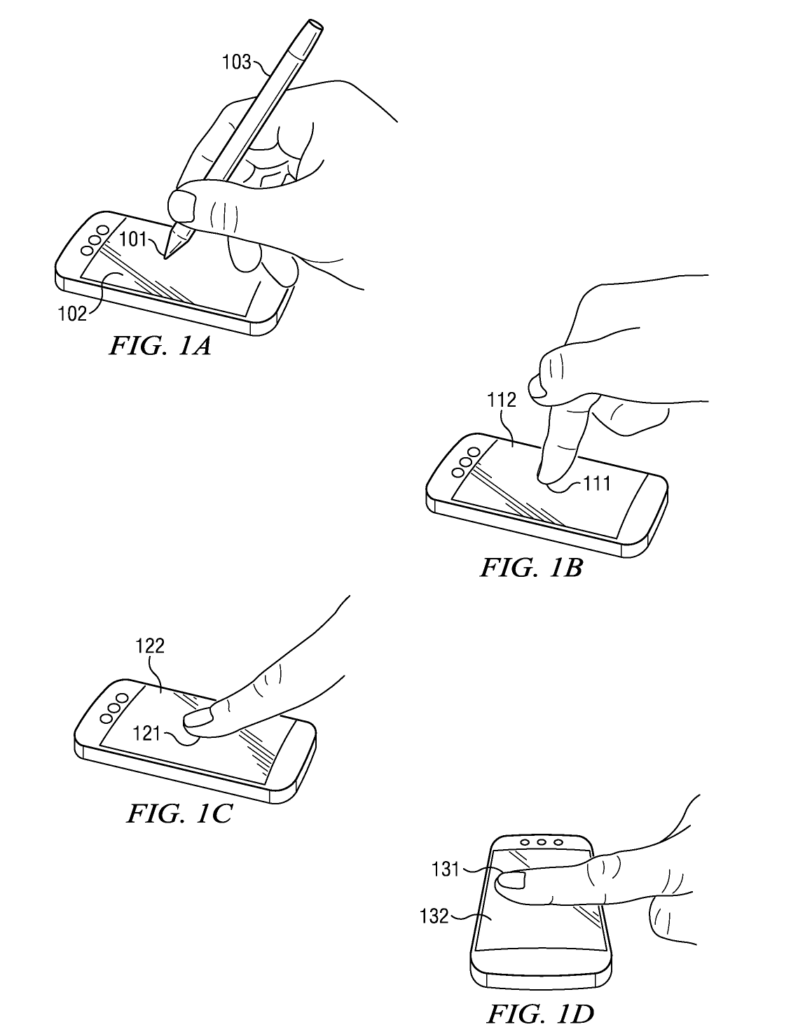

An embodiment of the invention and its potential advantages are understood by referring to FIGS. 1 through 8 of the drawings.

In an example embodiment a user may invoke display of a plurality of menu items by performing a rotationally pivoting touch input. In this regard, a touch input is rotationally pivoting in regards to rotational movement about a reference axis extending outward from, such as perpendicular to, a display, such as a touch display. In such an embodiment, the user may perform input to select one or more of the menu items. For example, a user may contact a pad of a finger with a touch display and rotate the finger to invoke display of a plurality of menu items. In such an example the user may move the finger to a position associated with a menu item to select the menu item.

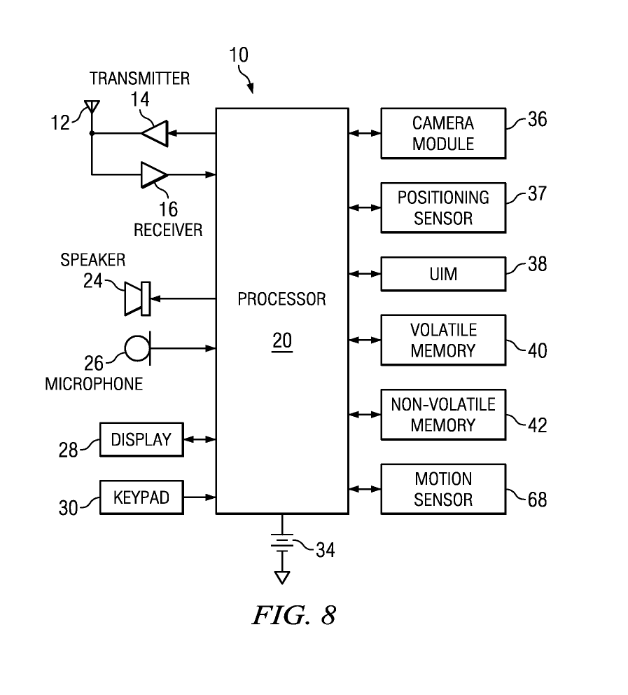

Without in any way limiting the scope, interpretation, or application of the claims appearing below, a technical effect of one or more of the example embodiments disclosed herein may be reducing the number of touch inputs received associated with receiving input to provide for display of menu items and associated with selecting at least one menu item. Another technical effect of one or more of the example embodiments disclosed herein may be reducing the load of a processor, for example processor 20 of FIG. 8, associated with receiving input to provide for display of menu items and associated with selecting at least one menu item. Another technical effect of one or more of the example embodiments disclosed herein may be reducing the power consumed by an apparatus associated with receiving input to provide for display of menu items and associated with selecting at least one menu item.

FIGS. 1A-1D are diagrams illustrating examples of a contact associated with a touch input according to an example embodiment. The examples of FIGS. 1A-1D are merely examples of contacts and do not limit the invention. For example, a different body part, such as a wrist, elbow, foot, toe, chin, shoulder, and/or the like may contact the touch display and serve as the touch input. In another example, a different object, such as a book, a card, a ball, and/or the like, may contact the touch display and provide the touch input.

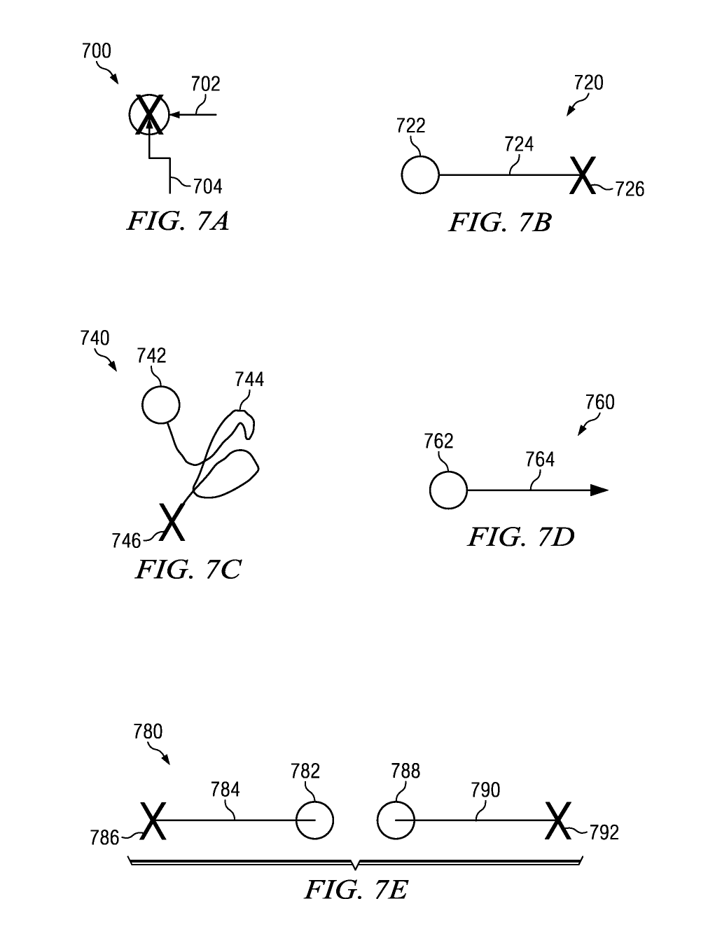

FIG. 1A is a diagram illustrating a tip 101 of a stylus 103 contacting a touch display 102, such as display 28 of FIG. 8, associated with a touch input, such as touch input 700 of FIG. 7A according to an example embodiment. Stylus 103 may be a device designed to be a stylus, or may be a device merely used as a stylus, such as a pen, a pencil, a pointer, and/or the like.

FIG. 1B is a diagram illustrating a finger tip 111 contacting a touch display 112, such as display 28 of FIG. 8, associated with a touch input, such as touch input 720 of FIG. 7B according to an example embodiment. Although the example of FIG. 1B illustrates the tip of an index finger, one or more other finger tips, such as the middle finger tip, may perform contact.

FIG. 1C is a diagram illustrating a finger pad 121 contacting a touch display 122, such as display 28 of FIG. 8, associated with a touch input, such as touch input 740 of FIG. 7C according to an example embodiment. In an example embodiment, the pad of a finger relates to a region of the finger between the tip of the finger and the joint of the finger closest to the tip. Although the example of FIG. 1C illustrates the pad of an index finger, one or more other finger pads, such as the middle finger pad, may perform contact.

FIG. 1D is a diagram illustrating a majority part of finger 131 contacting a touch display 132, such as display 28 of FIG. 8, associated with a touch input, such as touch input 700 of FIG. 7A according to an example embodiment. In an example embodiment, the majority part of the finger relates to a region of the finger between the tip of the finger and a joint of the finger at least two joints away from the tip of the finger. Even though the example of FIG. 1D illustrates the bottom of the finger contacting the touch display, other faces, such as the back, of the finger may contact the touch display.

In an example embodiment a user invokes display of a plurality of menu items by pivotally rotating a contact associated with a touch input. For example, the user may contact the touch display with a pad of a finger, similarly as illustrated in FIG. 1C, and rotate the pad of the finger in place. In another example, the user may contact the tip of a stylus, similarly as illustrated in FIG. 1A, and rotate the stylus in place. In still another example, the user may contact the tip of a finger, similarly as illustrated in FIG. 1B, and rotate the tip of the finger, with respect to the display, while moving the finger across at least part of the display.

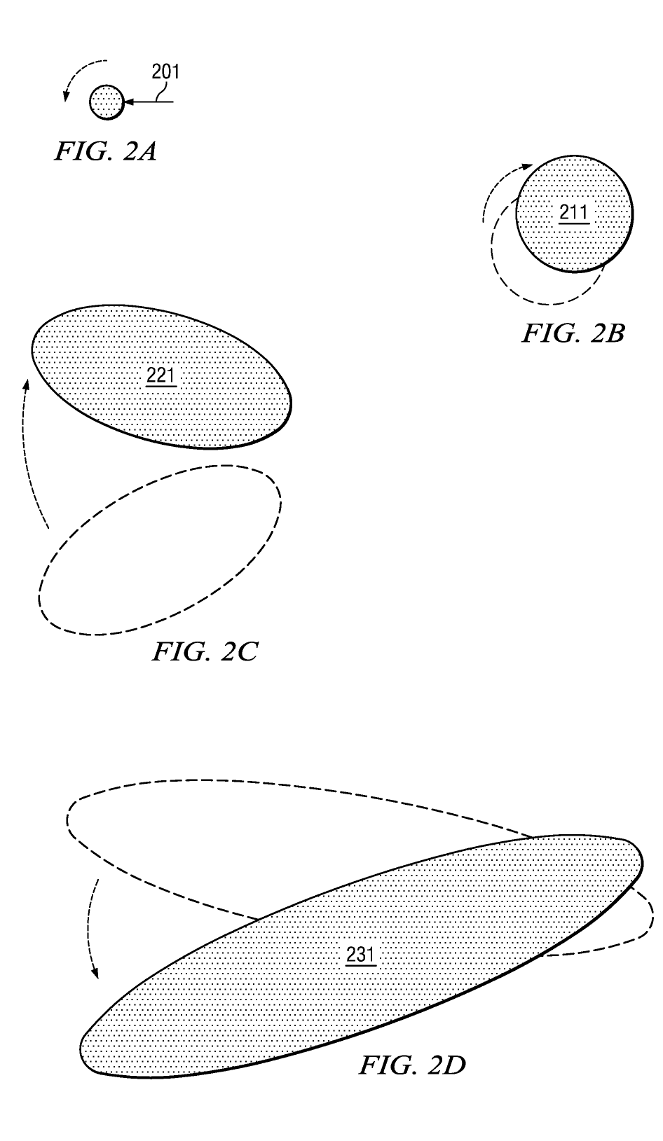

FIGS. 2A-2D are diagrams illustrating a contact region associated with a rotationally pivoting touch input according to an example embodiment. Although the contact regions of the examples of FIGS. 2A-2D illustrate elliptical regions, the shape of the contact region may vary and does not limit the claims below.

FIG. 2A is a diagram illustrating contact region 201 associated with a rotationally pivoting touch input according to an example embodiment. Although the example of FIG. 2A illustrates counter-clockwise rotation, the rotationally pivoting input may relate to clockwise rotation. In addition, even though the example of FIG. 2A illustrates a lack of positional change of any part of contact region 201, a rotationally pivoting input may relate to a positional change associated with a part of contact region 201, a positional change associated with the entirety of contact region 201, and/or the like. In an example embodiment, contact region 201 is associated with a touch display contact, such as the contact illustrated in FIG. 1A. Contact region 201 may be associated with a touch input, such as touch input 700 of FIG. 7A.

FIG. 2B is a diagram illustrating contact region 211 associated with a rotationally pivoting touch input according to an example embodiment. Although the example of FIG. 2B illustrates clockwise rotation, the rotationally pivoting input may relate to counter-clockwise rotation. In addition, even though the example of FIG. 2B illustrates a positional change of part of contact region 211, a rotationally pivoting input may relate to a lack of positional change associated with any part of contact region 211, a positional change associated with the entirety of contact region 211, and/or the like. In an example embodiment, contact region 211 is associated with a touch display contact, such as the contact illustrated in FIG. 1B. Contact region 211 may be associated with a touch input, such as touch input 700 of FIG. 7A, touch input 720 of FIG. 7B, touch input 740 of FIG. 7C, touch input 760 of FIG. 7D, and/or the like.

FIG. 2C is a diagram illustrating contact region 221 associated with a rotationally pivoting touch input according to an example embodiment. Although the example of FIG. 2C illustrates clockwise rotation, the rotationally pivoting input may relate to counter-clockwise rotation. In addition, even though the example of FIG. 2C illustrates a positional change of the entirety of contact region 221, a rotationally pivoting input may relate to a lack of positional change associated with any part of contact region 221, a positional change associated with a part of contact region 221, and/or the like. In an example embodiment, contact region 221 is associated with a touch display contact, such as the contact illustrated in FIG. 1C. Contact region 221 may be associated with a touch input, such as touch input 700 of FIG. 7A, touch input 720 of FIG. 7B, touch input 740 of FIG. 7C, touch input 760 of FIG. 7D, and/or the like.

FIG. 2D is a diagram illustrating contact region 231 associated with a rotationally pivoting touch input according to an example embodiment. Although the example of FIG. 2D illustrates counter-clockwise rotation, the rotationally pivoting input may relate to clockwise rotation. In addition, even though the example of FIG. 2D illustrates a positional change of a part of contact region 231, a rotationally pivoting input may relate to a lack of positional change associated with any part of contact region 231, a positional change associated with the entirety of contact region 231, and/or the like. In an example embodiment, contact region 231 is associated with a touch display contact, such as the contact illustrated in FIG. 1D. Contact region 231 may be associated with a touch input, such as touch input 700 of FIG. 7A, touch input 720 of FIG. 7B, touch input 740 of FIG. 7C, touch input 760 of FIG. 7D, and/or the like.

In an example embodiment, a menu item may relate to one or more setting, information item, operation, text, icon, image, sound, color, sound, video, and/or the like. For example, a menu item may relate to text associated with setting, such as color setting, volume setting, communication setting, text editing setting, and/or the like. In another example, a menu item may relate to an icon associated with an information item, which may be associated with a file, song, video, and/or the like. In yet another example, a menu item may relate to a sound, such as a song, ringtone, and/or the like. In still another example, a menu item may relate to an image, such as a button, icon, photo, and/or the like. In a further example, a menu item may relate to an operation, such as a copy operation, a paste operation, a save operation, and/or the like.

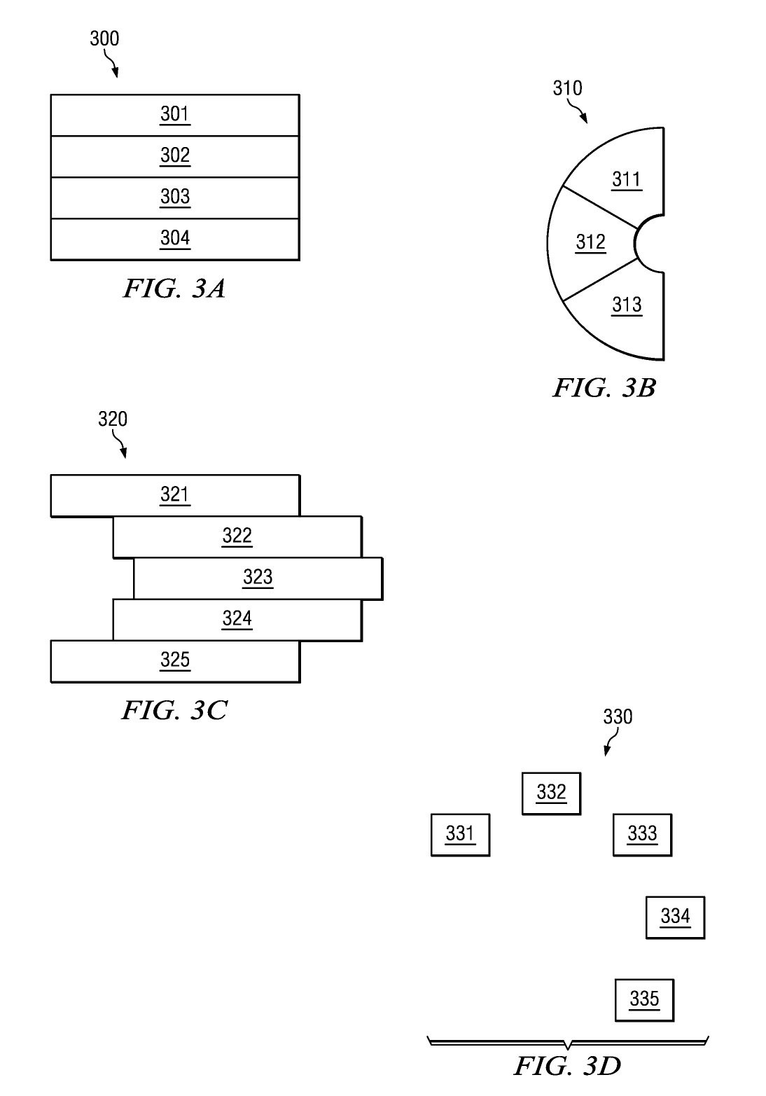

FIGS. 3A-3D are diagrams illustrating a plurality of menu items according to an example embodiment. The arrangement of menu items may vary in ways different from those illustrated in the examples of FIGS. 3A-3D. The examples of FIGS. 3A-3D are merely examples, and do not limit the claims below.

FIG. 3A is a diagram illustrating an arrangement 300 of a plurality of menu items 301-304, according to an example embodiment. In the example of FIG. 3A, arrangement 300 relates to a linear arrangement. Although arrangement 310 relates to a vertical linear arrangement, an arrangement of menu items may relate to a horizontal arrangement, a diagonal arrangement, and/or the like. Even though the example of FIG. 3A illustrates four menu items, the number of menu items may vary and does not limit the claims below.

FIG. 3B is a diagram illustrating an arrangement 310 of a plurality of menu items 311-313, according to an example embodiment. In the example of FIG. 3B, arrangement 310 relates to a curved arrangement. Although arrangement 310 relates to a leftward curve, an arrangement of menu items may relate to a rightward curve, an upward curve, a downward curve, and/or the like. Even though the example of FIG. 3B illustrates three menu items, the number of menu items may vary and does not limit the claims below.

FIG. 3C is a diagram illustrating an arrangement 320 of a plurality of menu items 321-325, according to an example embodiment. In the example of FIG. 3C, arrangement 320 relates to a curved arrangement. Although arrangement 320 relates to a rightward curve, an arrangement of menu items may relate to a leftward curve, an upward curve, a downward curve, and/or the like. Even though the example of FIG. 3C illustrates five menu items, the number of menu items may vary and does not limit the claims below.

FIG. 3D is a diagram illustrating an arrangement 330 of a plurality of menu items 331-335, according to an example embodiment. In the example of FIG. 3D, arrangement 330 relates to a curved arrangement. Although arrangement 330 relates to a rightward and upward curve, an arrangement of menu items may relate to a leftward curve, a downward curve, and/or the like. Even though the example of FIG. 3D illustrates five menu items, the number of menu items may vary and does not limit the claims below.

In an example embodiment, a user may perform selection of a menu item to invoke one or more operations associated with the menu item. For example, the user may select a menu item related to executing a program, modifying a setting, performing an operation, modifying an information item, and/or the like. For example, selection of a menu item may result in displaying an image associated with the menu item. In another example, selection of a menu item may terminate a program associated with the menu item. In still another example, selection of a menu item may modify a setting associated with the menu item, such as a volume setting, a communication setting, a text editing setting, and/or the like.

In an example embodiment, a touch input relates to a menu item selection. For example a user may perform a drag input to indicate a menu item for selection. In another example, a user may perform a rotationally pivoting touch input to indicate a menu item for selection. In an example embodiment, the user may perform a touch input indicating a menu item selection without terminating contact after the touch input associated with invoking the display of the menu items. For example, the user may perform a rotationally pivoting input to invoke display of menu items, then, without removing contact from the display, drag the contact to a position associated with a menu item to indicate selection. In another example embodiment, the user may release contact from the display after performing a touch input invoking display of menu items, then tap the display at a position associated with a menu item to indicate selection.

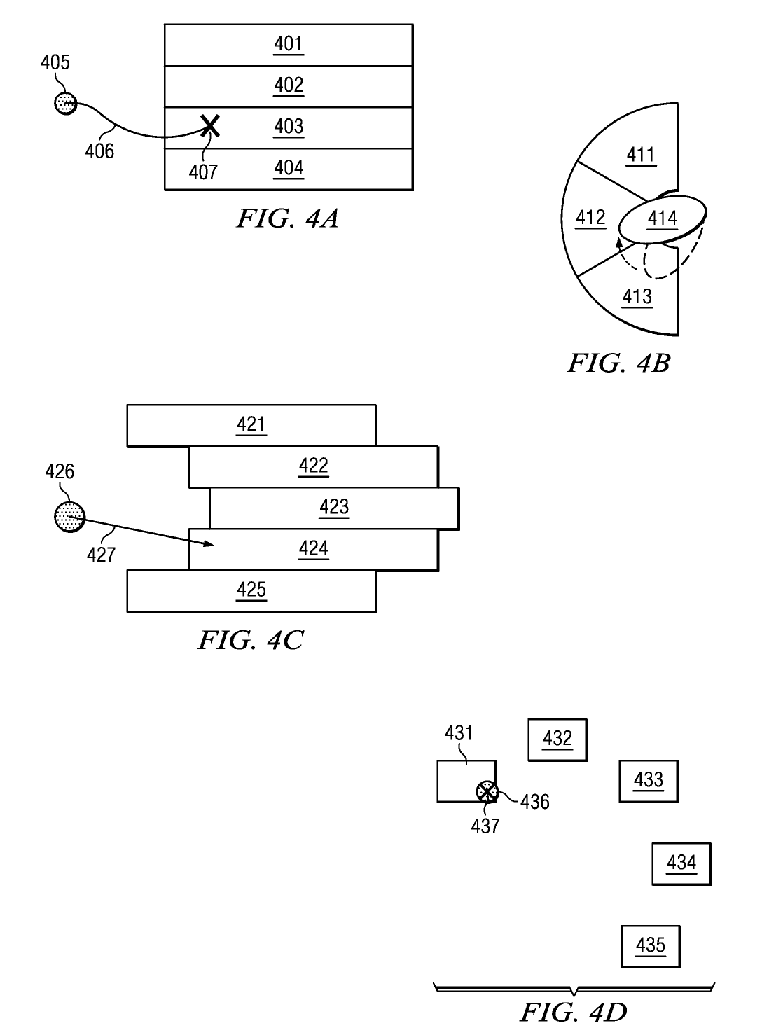

FIGS. 4A-4D are diagrams illustrating selection of a menu item according to an example embodiment. The examples of FIGS. 4A-4D are merely examples, and do not limit the claims below. The arrangement of menu items may vary in ways other than illustrated in the examples of FIGS. 4A-4D. In addition, input associated with selection of a menu item may vary in ways other than illustrated in the examples of FIGS. 4A-4D. Furthermore, selection may relate to more than one menu item. Even though the examples of FIGS. 4A-4D illustrate a contact input, a touch input associated with menu item selection may relate to a continuous stroke input. For example, a continuous stroke input may comprise a rotationally pivoting input and a touch input associated with selection without an intermediate release input.

FIG. 4A is a diagram illustrating selection of a menu item according to an example embodiment. The example of FIG. 4A illustrates menu items 401-404. Contact input 405, movement input 406, and release input 407 may be similar to touch input 740 of FIG. 7C. Contact input 405, movement input 406, and release input 407 relate to selection of menu item 403. In an example embodiment, selection of a menu item is based, at least in part on a position associated with a touch input. For example, selection may relate to a menu item, such as menu item 403, associated with a position relating to a release input, such as release input 407, a position relating to a movement input, such as movement input 406, a contact input, such as contact input 405, and/or the like.

FIG. 4B is a diagram illustrating selection of a menu item according to an example embodiment. The example of FIG. 4B illustrates menu items 411-413. rotationally pivoting input 414 may be similar to the example of rotationally pivoting touch input of FIG. 2D. Rotationally pivoting input 414 relates to selection of menu item 412. In an example embodiment, selection of a menu item is based, at least in part on a direction associated with a touch input. For example, selection may relate to a menu item, such as menu item 412, associated with a direction relating to a release input, such as release input 414.

FIG. 4C is a diagram illustrating selection of a menu item according to an example embodiment. The example of FIG. 4C illustrates menu items 421-425. Contact input 426, and movement input 427 may be similar to touch input 760 of FIG. 7D. Contact input 426, and movement input 427 relate to selection of menu item 424. In an example embodiment, selection of a menu item is based, at least in part on a position associated with a touch input. For example, selection may relate to a menu item, such as menu item 424, associated with a position relating to a movement input, such as movement input 427, a contact input, such as contact input 426, and/or the like. In an example embodiment, selection of a menu item is based, at least in part on a direction associated with a touch input. For example, selection may relate to a menu item, such as menu item 424, associated with a direction relating to a movement input, such as movement input 427.

FIG. 4D is a diagram illustrating selection of a menu item according to an example embodiment. The example of FIG. 4D illustrates menu items 421-425. Contact input 436 and release input 437 may be similar to touch input 700 of FIG. 7A. Contact input 436 and release input 437 relate to selection of menu item 421. In an example embodiment, selection of a menu item is based, at least in part on a position associated with a touch input. For example, selection may relate to a menu item, such as menu item 421, associated with a position relating to a release input, such as release input 437, a contact input, such as contact input 436, and/or the like.

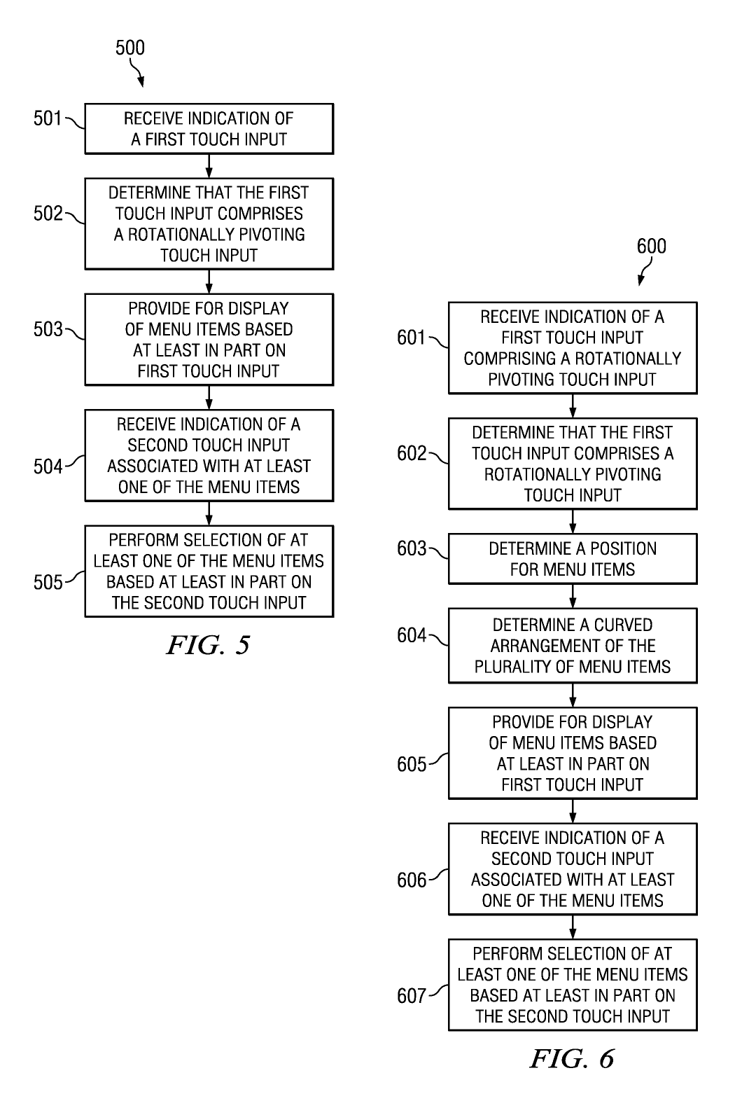

FIG. 5 is a flow diagram showing a set of operations 500 for selecting a menu item according to an example embodiment. An apparatus, for example electronic device 10 of FIG. 8, may utilize the set of operations 500. The apparatus may comprise means, including, for example, the processor 20, for performing the operations of FIG. 8.

At block 501, the apparatus receives indication of a first touch input. The apparatus may receive indication of the first touch input by retrieving information from one or more memories, such as non-volatile memory 42 of FIG. 8, receiving one or more indications of the first touch input from a part of the apparatus, such as a display for example display 28 of FIG. 8, receiving indication of the first touch input from a receiver, such as receiver 16 of FIG. 5, and/or the like. In an example embodiment, the apparatus may receive the first touch input from a different apparatus comprising a display, such as an external monitor.

At block 502, the apparatus determines that the first touch input comprises a rotationally pivoting touch input, such as one of the rotationally pivoting inputs of FIGS. 2A-2D. For example, the determination may comprise evaluating touch input information associated with movement, position, contact region, orientation, and/or the like. In addition, the apparatus may compare the touch input information to predefined threshold(s) and only identify the touch input information to be indicative of a rotationally pivoting input in instances in which the touch input information satisfy the predefined threshold(s). For example, thresholds may be predefined relating to the minimum angular movement required to be a rotationally pivoting input and the maximum time period within which the rotationally pivoting input must take place. To identify a rotationally pivoting input, an apparatus of this embodiment must therefore identify a rotationally pivoting input that includes at least the minimum angular movement within the maximum time period. By employing one or more predefined thresholds, the apparatus of this embodiment may avoid the identification of inadvertent rotational movements as a rotationally pivoting input that is intended to cause the display of a menu.

At block 503, the apparatus provides for display of a plurality of menu items based at least in part on the first touch input. Providing for display of the menu items may comprise storing information associated with the menu items to one or more memories, such as non-volatile memory 42 of FIG. 8, sending information associated with the menu items to a part of the apparatus, such as a display for example display 28 of FIG. 8, sending information associated with the menu items to a transmitter, such as transmitter 14 of FIG. 5, and/or the like. In an example embodiment, the apparatus may send information associated with the menu items to a different apparatus comprising a display, such as an external monitor. In regards to the menu items, the apparatus may associate a first plurality of menu items with a first rotationally pivoting input, such as a clockwise rotationally pivoting input and/or a first predefined translational movement such as shown in FIG. 2b, and associate a second plurality of menu items with a second rotationally pivoting input, such as a counterclockwise rotationally pivoting input and/or a second predefined translational movement. Thus, a user may cause either one of two different menus to be displayed depending upon the direction of the rotationally pivoting input and/or the type of translational movement associated with the rotationally pivoting input.

At block 504, the apparatus receives indication of a second touch input associated with at least one of the menu items. The receiving of the indication of the second touch input may be similar as described with reference to block 501. In an example embodiment, the first touch input and the second touch input relate to a single continuous stroke input. For example, the first touch input and the second touch input may be received absent an intermediate contact input and/or release input. In another example embodiment, the second touch input relates to a discontinuous input from the first touch input. For example, there may be at least one intermediate contact input and/or release input associated with the first touch input and the second touch input. The second touch input may comprise a rotationally pivoting input, such as illustrated the example of FIG. 2C, a tap input, such as touch input 700 of FIG. 7A, a drag input, such as touch input 740 of FIG. 7C, and/or the like.

At block 505, the apparatus performs selection of at least one of the menu items based at least in part on the second touch input. The apparatus may base the selection of the at least one menu item on a direction associated with the second touch input, a position associated with the second touch input, and/or the like.

FIG. 6 is another flow diagram showing a set of operations 600 for representing text information according to an example embodiment. An apparatus, for example electronic device 10 of FIG. 8, may utilize the set of operations 600. The apparatus may comprise means, including, for example, the processor 20, for performing the operations of FIG. 8.

At block 601, the apparatus receives indication of a first touch input. The operation of block 601 is similar as described with reference to block 501 of FIG. 5.

At block 602, the apparatus determines that the first touch input comprises a rotationally pivoting touch input. The operation of block 602 is similar as described with reference to block 502 of FIG. 5.

At block 603, the apparatus determines a position for the menu items. The determined position may relate to a display position for the menu items. The apparatus may determine the position for the menu items based on a predetermined setting, a position associated with the first touch input, and/or the like. For example, the apparatus may determine a position based on a predetermined setting and a position associated with the first touch input. In such an example, the apparatus may determine a position according to a predetermined position related to the left half of a display if the first touch input relates to a position associated with the left half of the display. In another example, the determined position may be a position associated with the first touch input. In still another example, the apparatus may determine the position for the menu items based on size of the menu items. In such an example, the apparatus may determine a position that will allow the menu items to fit within a predetermined area, such as within a display, near a position associated with the first touch input.

At block 604, the apparatus determines a curved arrangement of the menu items, for example similar to arrangement 310 of FIG. 3B, arrangement 320 of FIG. 3C, arrangement 330 of FIG. 3D, and/or the like. The curved arrangement may relate to an upward curve, a downward curve, a leftward curve, a rightward curve, and/or the like. The apparatus may determine the direction associated with the menu items, such as a curve direction, based on a predetermined setting, a position associated with the first touch input, a direction associated with the first touch input, and/or the like. For example, the apparatus may arrange the menu items in accordance to a curve relating the rotational pivoting of the first touch input. In another example, the apparatus may arrange the menu items based, at least in part on a position associated with the first touch input in relation to a display. In such an example, the arrangement of menu items may relate to an upward curve for an associated position at the bottom half of the display, a downward curve for an associated position at the top half of the display, a leftward curve for an associated position at the right half of the display, a rightward curve for an associated position at the left half of the display, and/or the like.

At block 605, the apparatus provides for display of a plurality of menu items based at least in part on the first touch input. The operation of block 605 is similar as described with reference to block 503 of FIG. 5.

At block 606, the apparatus receives indication of a second touch input associated with at least one of the menu items. The operation of block 606 is similar as described with reference to block 504 of FIG. 5.

At block 607, the apparatus performs selection of at least one of the menu items based at least in part on the second touch input. The operation of block 607 is similar as described with reference to block 505 of FIG. 5.

FIGS. 7A-7E are diagrams illustrating input associated with a touch display, for example from display 28 of FIG. 8, according to an example embodiment. In FIGS. 7A-7E, a circle represents an input related to contact with a touch display, two crossed lines represent an input related to releasing a contact from a touch display, and a line represents input related to movement on a touch display.

In the example of FIG. 7A, input 700 relates to receiving contact input 702 and receiving a release input 704. In this example, contact input 702 and release input 704 occur at the same position. In an example embodiment, an apparatus utilizes the time between receiving contact input 702 and release input 704. For example, the apparatus may interpret input 700 as a tap for a short time between contact input 702 and release input 704, as a press for a longer time between contact input 702 and release input 704, and/or the like. In such an example, a tap input may induce one operation, such as selecting an item, and a press input may induce another operation, such as performing an operation on an item. In another example, a tap and/or press may relate to a user selected text position.

In the example of FIG. 7B, input 720 relates to receiving contact input 722, a movement input 724, and a release input 726. In this example, contact input 722 and release input 726 occur at different positions. Input 720 may relate to dragging an object from one position to another, to moving a scroll bar, to panning a virtual screen, to drawing a shape, and/or the like. In an example embodiment, an apparatus interprets input 720 based at least in part on the speed of movement 724. For example, if input 720 relates to panning a virtual screen, the panning motion may be small for a slow movement, large for a fast movement, and/or the like. In another example embodiment, an apparatus interprets input 720 based at least in part on the distance between contact input 722 and release input 726. For example, if input 720 relates to a scaling operation, such as resizing a box, the scaling may relate to the distance between contact input 722 and release input 726. An apparatus may interpret the input before receiving release input 726. For example, the apparatus may evaluate a change in the input, such as speed, position, and/or the like. In such an example, the apparatus may perform one or more determinations based upon the change in the touch input. In such an example, the apparatus may modify a text selection point based at least in part on the change in the touch input.

In the example of FIG. 7C, input 740 relates to receiving contact input 742, a movement input 744, and a release input 746 as shown. In this example, contact input 742 and release input 746 occur at different positions. Input 740 may relate to dragging an object from one position to another, to moving a scroll bar, to panning a virtual screen, to drawing a shape, and/or the like. In an example embodiment, an apparatus interprets input 740 based at least in part on the speed of movement 744. For example, if input 740 relates to panning a virtual screen, the panning motion may be small for a slow movement, large for a fast movement, and/or the like. In another example embodiment, an apparatus interprets input 740 based at least in part on the distance between contact input 742 and release input 746. For example, if input 740 relates to a scaling operation, such as resizing a box, the scaling may relate to the distance between contact input 742 and release input 746. In still another example embodiment, the apparatus interprets the position of the release input. In such an example, the apparatus may modify a text selection point based at least in part on the change in the touch input.

In the example of FIG. 7D, input 760 relates to receiving contact input 762, and a movement input 764, where contact is released during movement. Input 760 may relate to dragging an object from one position to another, to moving a scroll bar, to panning a virtual screen, to drawing a shape, and/or the like. In an example embodiment, an apparatus interprets input 760 based at least in part on the speed of movement 764. For example, if input 760 relates to panning a virtual screen, the panning motion may be small for a slow movement, large for a fast movement, and/or the like. In another example embodiment, an apparatus interprets input 760 based at least in part on the distance associated with the movement input 764. For example, if input 760 relates to a scaling operation, such as resizing a box, the scaling may relate to the distance of the movement input 764 from the contact input 762 to the release of contact during movement.

In an example embodiment, an apparatus may receive multiple touch inputs at coinciding times. For example, there may be a tap input at a position and a different tap input at a different location during the same time. In another example there may be a tap input at a position and a drag input at a different position. An apparatus may interpret the multiple touch inputs separately, together, and/or a combination thereof. For example, an apparatus may interpret the multiple touch inputs in relation to each other, such as the distance between them, the speed of movement with respect to each other, and/or the like.

In the example of FIG. 7E, input 780 relates to receiving contact inputs 782 and 788, movement inputs 784 and 790, and release inputs 786 and 792. In this example, contact input 782 and 788, and release input 786 and 792 occur at different positions. Input 780 may be characterized as a multiple touch input. Input 780 may relate to dragging an object from one position to another, to moving a scroll bar, to panning a virtual screen, to drawing a shape, to indicating one or more user selected text positions and/or the like. In an example embodiment, an apparatus interprets input 780 based at least in part on the speed of movements 784 and 790. For example, if input 780 relates to zooming a virtual screen, the zooming motion may be small for a slow movement, large for a fast movement, and/or the like. In another example embodiment, an apparatus interprets input 780 based at least in part on the distance between contact inputs 782 and 788 and release inputs 786 and 792. For example, if input 780 relates to a scaling operation, such as resizing a box, the scaling may relate to the collective distance between contact inputs 782 and 788 and release inputs 786 and 792.

In an example embodiment, the timing associated with the apparatus receiving contact inputs 782 and 788, movement inputs 784 and 790, and release inputs 786 and 792 varies. For example, the apparatus may receive contact input 782 before contact input 788, after contact input 788, concurrent to contact input 788, and/or the like. The apparatus may or may not utilize the related timing associated with the receiving of the inputs. For example, the apparatus may utilize an input received first by associating the input with a preferential status, such as a primary selection point, a starting position, and/or the like. In another example, the apparatus may utilize non-concurrent inputs as if the apparatus received the inputs concurrently. In such an example, the apparatus may utilize a release input received first the same way that the apparatus would utilize the same input if the apparatus had received the input second.

Even though an aspect related to two touch inputs may differ, such as the direction of movement, the speed of movement, the position of contact input, the position of release input, and/or the like, the touch inputs may be similar. For example, a first touch input comprising a contact input, a movement input, and a release input, may be similar to a second touch input comprising a contact input, a movement input, and a release input, even though they may differ in the position of the contact input, and the position of the release input.

FIG. 8 is a block diagram showing an apparatus, such as an electronic device 10, according to an example embodiment. It should be understood, however, that an electronic device as illustrated and hereinafter described is merely illustrative of an electronic device that could benefit from embodiments of the invention and, therefore, should not be taken to limit the scope of the invention. While one embodiment of the electronic device 10 is illustrated and will be hereinafter described for purposes of example, other types of electronic devices, such as, but not limited to, portable digital assistants (PDAs), pagers, mobile computers, desktop computers, televisions, gaming devices, laptop computers, media players, cameras, video recorders, global positioning system (GPS) devices and other types of electronic systems, may readily employ embodiments of the invention.

Furthermore, devices may readily employ embodiments of the invention regardless of their intent to provide mobility. In this regard, even though embodiments of the invention are described in conjunction with mobile communications applications, it should be understood that embodiments of the invention may be utilized in conjunction with a variety of other applications, both in the mobile communications industries and outside of the mobile communications industries.

The electronic device 10 may comprise an antenna 12 (or multiple antennae) in operable communication with a transmitter 14 and a receiver 16. The electronic device 10 may further comprise a processor 20 or other processing element that provides signals to and receives signals from the transmitter 14 and receiver 16, respectively. The signals may comprise signaling information in accordance with a communications interface standard, user speech, received data, user generated data, and/or the like. The electronic device 10 may operate with one or more air interface standards, communication protocols, modulation types, and access types. By way of illustration, the electronic device 10 may operate in accordance with any of a number of first, second, third and/or fourth-generation communication protocols or the like. For example, the electronic device 10 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), or with fourth-generation (4G) wireless communication protocols, wireless networking protocols, such as 802.11, short-range wireless protocols, such as Bluetooth, and/or the like.

As used in this application, the term ‘circuitry’ refers to all of the following: hardware-only implementations (such as implementations in only analog and/or digital circuitry) and to combinations of circuits and software and/or firmware such as to a combination of processor(s) or portions of processor(s)/software including digital signal processor(s), software, and memory(ies) that work together to cause an apparatus, such as a mobile phone or server, to perform various functions and to circuits, such as a microprocessor(s) or portion of a microprocessor(s), that require software or firmware for operation, even if the software or firmware is not physically present. This definition of ‘circuitry’ applies to all uses of this term in this application, including in any claims. As a further example, as used in this application, the term “circuitry” would also cover an implementation of merely a processor, multiple processors, or portion of a processor and its (or their) accompanying software and/or firmware. The term “circuitry” would also cover, for example, a baseband integrated circuit or applications processor integrated circuit for a mobile phone or a similar integrated circuit in a cellular network device or other network device.

Processor 20 may comprise means, such as circuitry for implementing audio, video, communication, navigation, logic functions, and or the like, as well as for implementing embodiments of the invention including, for example, one or more of the functions described in conjunction with FIGS. 1-7. For example, processor 20 may comprise means, such as a digital signal processor device, a microprocessor device, various analog to digital converters, digital to analog converters, processing circuitry and other support circuits, for performing various functions including, for example, one or more of the functions described in conjunction with FIGS. 1-7. The apparatus may perform control and signal processing functions of the electronic device 10 among these devices according to their respective capabilities. The processor 20 thus may comprise the functionality to encode and interleave message and data prior to modulation and transmission. The processor 20 may additionally comprise an internal voice coder, and may comprise an internal data modem. Further, the processor 20 may comprise functionality to operate one or more software programs, which may be stored in memory and which may, among other things, cause the processor 20 to implement at least one embodiment including, for example, one or more of the functions described in conjunction with FIGS. 2-7. For example, the processor 20 may operate a connectivity program, such as a conventional internet browser. The connectivity program may allow the electronic device 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic device 10 may comprise a user interface for providing output and/or receiving input. The electronic device 10 may comprise an output device such as a ringer, a conventional earphone and/or speaker 24, a microphone 26, a display 28, and/or a user input interface, which are coupled to the processor 20. The user input interface, which allows the electronic device 10 to receive data, may comprise means, such as one or more devices that may allow the electronic device 10 to receive data, such as a keypad 30, a touch display, for example if display 28 comprises touch capability, and/or the like. In an embodiment comprising a touch display, the touch display may be configured to receive input from a single point of contact, multiple points of contact, and/or the like. In such an embodiment, the touch display and/or the processor may determine input based on position, motion, speed, contact area, and/or the like.

The electronic device 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display.

In embodiments including the keypad 30, the keypad 30 may comprise numeric (for example, 0-9) keys, symbol keys (for example, #, *), alphabetic keys, and/or the like for operating the electronic device 10. For example, the keypad 30 may comprise a conventional QWERTY keypad arrangement. The keypad 30 may also comprise various soft keys with associated functions. In addition, or alternatively, the electronic device 10 may comprise an interface device such as a joystick or other user input interface. The electronic device 10 further comprises a battery 34, such as a vibrating battery pack, for powering various circuits that are required to operate the electronic device 10, as well as optionally providing mechanical vibration as a detectable output.

In an example embodiment, the electronic device 10 comprises a media capturing element, such as a camera, video and/or audio module, in communication with the processor 20. The media capturing element may be any means for capturing an image, video and/or audio for storage, display or transmission. For example, in an example embodiment in which the media capturing element is a camera module 36, the camera module 36 may comprise a digital camera which may form a digital image file from a captured image. As such, the camera module 36 may comprise hardware, such as a lens or other optical component(s), and/or software necessary for creating a digital image file from a captured image. Alternatively, the camera module 36 may comprise only the hardware for viewing an image, while a memory device of the electronic device 10 stores instructions for execution by the processor 20 in the form of software for creating a digital image file from a captured image. In an example embodiment, the camera module 36 may further comprise a processing element such as a co-processor that assists the processor 20 in processing image data and an encoder and/or decoder for compressing and/or decompressing image data. The encoder and/or decoder may encode and/or decode according to a standard format, for example, a Joint Photographic Experts Group (JPEG) standard format.

The electronic device 10 may comprise one or more user identity modules (UIM) 38. The UIM may comprise information stored in memory of electronic device 10, a part of electronic device 10, a device coupled with electronic device 10, and/or the like. The UIM 38 may comprise a memory device having a built-in processor. The UIM 38 may comprise, for example, a subscriber identity module (SIM), a universal integrated circuit card (UICC), a universal subscriber identity module (USIM), a removable user identity module (R-UIM), and/or the like. The UIM 38 may store information elements related to a subscriber, an operator, a user account, and/or the like. For example, UIM 38 may store subscriber information, message information, contact information, security information, program information, and/or the like. Usage of one or more UIM 38 may be enabled and/or disabled. For example, electronic device 10 may enable usage of a first UIM and disable usage of a second UIM.

In an example embodiment, electronic device 10 comprises a single UIM 38. In such an embodiment, at least part of subscriber information may be stored on the UIM 38.

In another example embodiment, electronic device 10 comprises a plurality of UIM 38. For example, electronic device 10 may comprise two UIM 38 blocks. In such an example, electronic device 10 may utilize part of subscriber information of a first UIM 38 under some circumstances and part of subscriber information of a second UIM 38 under other circumstances. For example, electronic device 10 may enable usage of the first UIM 38 and disable usage of the second UIM 38. In another example, electronic device 10 may disable usage of the first UIM 38 and enable usage of the second UIM 38. In still another example, electronic device 10 may utilize subscriber information from the first UIM 38 and the second UIM 38.

Electronic device 10 may comprise a memory device including, in one embodiment, volatile memory 40, such as volatile Random Access Memory (RAM) including a cache area for the temporary storage of data. The electronic device 10 may also comprise other memory, for example, non-volatile memory 42, which may be embedded and/or may be removable. The non-volatile memory 42 may comprise an EEPROM, flash memory or the like. The memories may store any of a number of pieces of information, and data. The information and data may be used by the electronic device 10 to implement one or more functions of the electronic device 10, such as the functions described in conjunction with FIGS. 1-7. For example, the memories may comprise an identifier, such as an international mobile equipment identification (IMEI) code, which may uniquely identify the electronic device 10.

Although FIG. 8 illustrates an example of an electronic device that may utilize embodiments of the invention including those described and depicted, for example, in FIGS. 1-7, electronic device 10 of FIG. 8 is merely an example of a device that may utilize embodiments of the invention.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media. In the context of this document, a “computer-readable medium” may be any tangible media or means that can contain, or store the instructions for use by or in connection with an instruction execution system, apparatus, or device, such as a computer, with one example of a computer described and depicted in FIG. 8. A computer-readable medium may comprise a computer-readable storage medium that may be any tangible media or means that can contain or store the instructions for use by or in connection with an instruction execution system, apparatus, or device, such as a computer.

If desired, the different functions discussed herein may be performed in a different order and/or concurrently with each other. For example, block 604 may be performed before block 603. Furthermore, if desired, one or more of the above-described functions may be optional or may be combined. For example, block 604 may be omitted.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1-82. (canceled)

83. An apparatus, comprising:
a processor;
memory including computer program code, the memory and the computer program code configured to, working with the processor, cause the apparatus to perform at least the following:
receive indication of a first touch input;
determine that said first touch input comprises a rotationally pivoting touch input;
provide for display of a plurality of menu items based at least in part on said first touch input and the determination that said first touch input comprises a rotationally pivoting touch;
receive indication of a second touch input associated with at least one of said menu items; and
perform selection of at least one of said menu items based at least in part on said second touch input.

84. The apparatus of claim 83, wherein at least one of said first touch or said second touch input relates to at least one of a group comprising a tip of a finger, a pad of a finger, and a side of a finger.

85. The apparatus of claim 83, wherein said first touch input and said second touch input relate to a single continuous stroke input.

86. The apparatus of claim 83, wherein said second touch input comprises a rotationally pivoting input.

87. The apparatus of claim 83, wherein said second touch input comprises at least one of a group consisting of a tap input and a drag input.

88. The apparatus of claim 83, wherein said selection is based at least in part on a direction associated with said second touch input.

89. The apparatus of claim 83, wherein said selection is based at least in part on a position associated with said second touch input.

90. The apparatus of claim 83, wherein the memory and the computer program code is further configured to, working with the processor, cause the apparatus to perform at least: determine a position for said menu items.

91. The apparatus of claim 90, wherein said position for said menu items is determined based at least in part on a position associated with said first touch input.

92. The apparatus of claim 83, wherein the memory and the computer program code is further configured to, working with the processor, cause the apparatus to perform at least: determine a curved arrangement of said menu items.

93. The apparatus of claim 92, wherein said curved arrangement relates to a direction associated with said first touch input.

94. The apparatus of claim 92, wherein said curved arrangement relates to a position associated with said first touch input.

95. The apparatus of claim 92, wherein said curved arrangement relates to a leftward curve.

96. The apparatus of claim 92, wherein said curved arrangement relates to a rightward curve.

97. The apparatus of claim 92, wherein said curved arrangement relates to an upward curve.

98. The apparatus of claim 92, wherein said curved arrangement relates to a downward curve.

99. The apparatus of claim 83, further comprising a touch display.

100. The apparatus of claim 83, wherein said apparatus is a mobile device.

101. A method, comprising:
receiving indication of a first touch input;
determining that said first touch input comprises a rotationally pivoting touch input;
providing for display of a plurality of menu items based at least in part on said first touch input and the determination that said first touch input comprises a rotationally pivoting touch;
receiving indication of a second touch input associated with at least one of said menu items; and
performing selection of at least one of said menu items based at least in part on said second touch input.

102. The method of claim 101, wherein said first touch input and said second touch input relate to a single continuous stroke input.

103. The method of claim 101, wherein said second touch input comprises a rotationally pivoting input.

104. A computer-readable medium encoded with instructions that, when executed by a computer, perform:
receiving indication of a first touch input;
determining that said first touch input comprises a rotationally pivoting touch input;
providing for display of a plurality of menu items based at least in part on said first touch input and the determination that said first touch input comprises a rotationally pivoting touch;
receiving indication of a second touch input associated with at least one of said menu items; and
performing selection of at least one of said menu items based at least in part on said second touch input.

105. The computer readable medium of claim 104, wherein said first touch input and said second touch input relate to a single continuous stroke input.

106. The computer readable medium of claim 105, wherein said second touch input comprises a rotationally pivoting input.
